(19) United States
(12) Patent Application Publication
(10) Pub. No.: US 2023/0420755 A1
(43) Pub. Date: Dec. 28, 2023

(54) BATTERY MODULE, CIRCUIT BOARD AND BATTERY POWER OPTIMIZATION METHOD

(71) Applicant: Qisda Corporation, Taoyuan City (TW)

(72) Inventor: Shih-Min HSIANG, Taoyuan City (TW)

(73) Assignee: Qisda Corporation, Taoyuan City (TW)

(21) Appl. No.: 18/105,885

(22) Filed: Feb. 6, 2023

(30) Foreign Application Priority Data
Jun. 22, 2022 (CN) 202210713867.6

(51) Int. Cl. H01M 10/48; H02J 7/00; H01M 10/615; H01M 10/63; H01M 10/42; H01M 10/44

(52) U.S. Cl. CPC H01M 10/48; H02J 7/0048; H02J 7/00712; H01M 10/615; H01M 10/63; H01M 10/425; H01M 10/44

(57) ABSTRACT

The present invention discloses a battery module, a circuit board and an battery power optimization method. The battery power optimization method includes: activating a battery unit to cause the battery unit to discharge; obtaining a voltage value and a current value of the battery unit; and driving a heating unit to heat the battery unit according to the voltage value and the current value.

This application claims the benefit of People's Republic of China application Serial No. 202210713867.6, filed Jun. 22, 2022, the subject matter of which is incorporated herein by reference.

### BACKGROUND OF THE INVENTION

### Field of the Invention

The invention relates in general to a battery module, the circuit board and the battery power optimization method.

### Description of the Related Art

Battery is a means to supply necessary power to an electronic device. When an electronic device is activated, battery will change from a non-discharging state to a discharging state. Battery temperature is an important factor that affects internal impedance (internal resistance) of a battery. Generally speaking, the lower the battery temperature, the larger the internal resistance. Under the same requirement of current, the larger the internal resistance, the smaller the voltage. That is, when an electronic device is activated, if the battery temperature is too low, the voltage may not be high enough to drive the elements of the electronic device to operate. Through the heat generated from heat loss, the internal resistance will be decreases as the battery temperature is gradually increased. Particularly, at a cold environment, the ambient temperature of the battery can be as low as −20° C., and the method of gradually increasing battery temperature through the heat generated from heat loss normally is time consuming.

### SUMMARY OF THE INVENTION

According to one embodiment of the present invention, a battery module is provided. The battery module includes a battery unit, a heating unit, a detection unit and a drive control unit. The detection unit is coupled to the battery unit and is configured to obtain a voltage value and a current value of the battery unit. The drive control unit is coupled to the detection unit and the heating unit and is configured to drive the heating unit to heat the battery unit according to the voltage value and the current value

According to another embodiment of the present invention, a circuit board is provided. The circuit board includes a battery slot, a heating unit, a detection unit and a drive control unit. The battery slot is configured to arrange a battery unit. The detection unit is configured to obtain a voltage value and a current value of the battery unit. The drive control unit is coupled to the detection unit and the heating unit and is configured to drive the heating unit to heat the battery unit according to the voltage value and the current value.

According to an alternate embodiment of the present invention, a battery power optimization method is provided. The battery power optimization method includes: activating a battery unit to cause the battery unit to discharge; obtaining a voltage value and a current value of the battery unit; and driving a heating unit to heat the battery unit according to the voltage value and the current value.

The above and other aspects of the invention will become better understood with regard to the following detailed description of the preferred but non-limiting embodiment (s). The following description is made with reference to the accompanying drawings.

### BRIEF DESCRIPTION OF THE DRAWINGS

FIG. 1 is a block diagram of a battery module according to an embodiment of the present invention;

FIG. 2 is a block diagram of a circuit board according to an embodiment of the present invention;

FIG. 3 is a flowchart of a battery power optimization method according to an embodiment of the present invention.

### DETAILED DESCRIPTION OF THE INVENTION

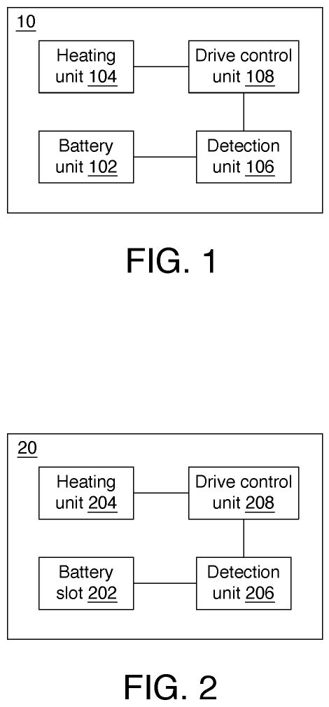

Referring to FIG. 1, a block diagram of a battery module according to an embodiment of the present invention is shown. The battery module 10 includes a battery unit 102, a heating unit 104, a detection unit 106 and a drive control unit 108.

The battery unit 102 can be realized by an element or a combination of several elements capable of storing and releasing electricity. For example, the battery unit 102 can be realized by any existing batteries such as lithium batteries or alkaline batteries.

The heating unit 104 is an element or a combination of several elements capable of heating one or more objects, such that these objects can obtain heat. For example, the heating unit 104 can be realized by a heating sheet or an infrared heater.

The detection unit 106 is coupled to the battery unit 102 and is configured to obtain a voltage value and a current value of the battery unit 102. In an embodiment, the voltage value refers to the voltage difference between the positive pole and the negative pole of the battery unit; the current value refers to the magnitude of current discharged from the battery unit.

The drive control unit 108 is coupled to the detection unit 106 and the heating unit 104 and is configured to drive the heating unit 104 to heat the battery unit 102 according to the voltage value and the current value. In an embodiment, the drive control unit 108 may include a control unit and a drive circuit. The control unit can be realized by a micro-chip configured to generate a control signal according to the voltage value and the current value of the battery unit 102 detected by the detection unit 106. The drive circuit may include several electronic elements, and can be realized by such as transistors, capacitors, and resistors. The drive circuit is configured to drive the heating unit 104 to heat the battery unit 102 according to the control signal. In an embodiment, the electricity of the drive control unit 108 is provided by the battery unit 102.

In an embodiment, the battery module 10 can be disposed in an electronic device to provide electricity to an electronic device. The heating unit 104 is a heating sheet. The heating unit 104 can be disposed on a surface of the battery unit 102. For example, the heating unit 104 can be fixed on a surface of the battery unit 102 by way of adhesion. When the user activates an electronic device, the battery unit 102 is caused to discharge. The detection unit 106 detects the current value and the voltage value of the current unit 102 and then transmits the detected current value and voltage value to a control unit which controls the drive control unit 108. Then, the control unit calculates an internal impedance value of the battery unit 102 according to the current value and the voltage value. For example, the control unit divides the voltage value by the current value to obtain the impedance value of the battery unit 102. The control unit determines the control signal according to the impedance value of the battery unit 102 and transmits the control signal to the drive circuit of the drive control unit 108. The drive circuit generates the drive current according to the control signal. The heating unit 104 generates heat according to the value of the drive current (driving current value) and heats the battery unit 102 according to the generated heat.

In an embodiment, the drive control unit 108 can further compare the impedance value of the battery unit 102 obtained through calculation with an upper limit and a lower limit and generate a drive current according to the impedance value and the comparison result. When the impedance value is less than the lower limit, this indicates that the current impedance of the battery unit 102 is small enough and the battery unit 102 is able to generate a voltage large enough to drive the element load of the electronic device. This also may indicate that although the impedance of the battery unit 102 is slightly too large to activate the battery unit 102 to generate a voltage large enough to drive the element load of the electronic device, the temperature increase caused by the heat of the heat loss generated from the discharging of the battery unit 102 also allows the impedance to drop to a level at which the battery unit 102 can generate a voltage large enough to drive the element load of the electronic device. Hence, when the impedance value is less than the lower limit, the drive circuit 108 can be controlled not to drive the heating unit 104 to heat the battery unit 102. When the impedance value is between the upper limit and the lower limit, the relationship between the driving current value and the impedance value can be linear. When the impedance value is greater than the upper limit, this may possibly indicate that the temperature of the battery unit 102 is very low. Hence, when the impedance value is greater than the upper limit, the drive control unit 108 can increase the driving current value in a non-linear manner to drive the heating unit 104 to quickly increase the temperature of the battery unit 102.

In an embodiment, the drive control unit 108 stores a conversion table, which records the driving current value corresponding to the current value and the voltage value. The drive control unit 108 determines the driving current value by looking up the conversion table according to the current value and the voltage value of the battery unit 102 provided by the detection unit 106. For example, the drive control unit 100 stores the conversion table. The drive control unit 108 obtains an impedance value of the battery unit by looking up the conversion table according to the voltage value and the current value and drives the heating unit to heat the battery unit according to the impedance value.

In an embodiment, the drive control unit 108 drives the heating unit 104 to heat the battery unit 102 only when the impedance value is between the lower limit and the upper limit. When the impedance value is less than the lower limit or is greater than the upper limit, the drive control unit 108 does not drive the heating unit 104 to heat the battery unit 102.

In an embodiment, when the impedance value is between the lower limit and the upper limit, the drive control unit 108 outputs a drive current with a fixed driving current value to drive the heating unit 104 to heat the battery unit 102. When the impedance value is less than the lower limit, the drive control unit 108 reduces the driving current value of the outputted drive current. When the impedance value is greater than the upper limit, the drive control unit 108 increases the driving current value of the outputted drive current.

In an embodiment, the upper limit and the lower limit are adjustable. The drive control unit 108 can record a usage state of the battery unit 102, wherein the usage state may include various information relevant with the health of the battery unit 102, such as refreshed accumulative usage time and capacity limit. The drive control unit 108 can adjust the upper limit and the lower limit according to the usage state of the battery unit 102. For example, as the refreshed accumulative usage time of the battery unit 102 increases, the drive control unit 108 can lower the upper limit and the lower limit to lower the threshold for driving the heating unit 104 to heat the battery unit 102.

In an embodiment, the drive circuit 108 can set a target impedance value, compare the impedance value with the target impedance value, and determine the driving current value according to the comparison result. When the impedance value is less than the target impedance value, the drive circuit 108 can reduce the driving current value. When the impedance value is greater than the target impedance value, the drive circuit 108 can increase the driving current value.

In an embodiment, when the impedance value is less than or equivalent to the target impedance value, the drive circuit 108 can be controlled to stop driving the heating unit 104 to heat the battery unit 102. When the impedance value is greater than the target impedance value, the drive circuit 108 can increase the driving current value according to the difference between the impedance value and the target impedance value.

In an embodiment, the target impedance value can be dynamically adjusted.

Referring to FIG. 2, a block diagram of a circuit board according to an embodiment of the present invention is shown. The battery module 20 includes a battery slot 202, a heating unit 204, a detection unit 206 and a drive control unit 208.

The battery slot 202 is configured to arrange a battery unit. For example, the battery slot 202 can be an accommodation space in which the battery unit is arranged. The battery slot 202 may include several conducting contacts configured to couple the positive pole and the negative pole of the battery unit.

The heating unit 204 is similar to the heating unit 104 and can be used to heat the battery unit. The detection unit 206 is similar to the detection unit 106 and can be coupled to the battery unit to obtain the voltage value and the current value of the battery unit. The drive control unit 208 is similar to the drive control unit 108 and can be coupled to the detection unit 206 and the heating unit 204 to drive the heating unit 204 to heat the battery unit according to the voltage value and the current value.

In an embodiment, the heating unit 204 can be realized by a heating sheet disposed in the battery slot 202. When the battery unit is arranged in the battery slot 202, the heating unit 204 can be closer to or contact a surface of the battery unit.

In another embodiment, the heating unit 204 can be realized by an infrared heater disposed at the vicinity of the battery slot 202, so that when the battery unit is arranged in the battery slot 202, the battery unit is within the coverage of the infrared light outputted by the heating unit 204.

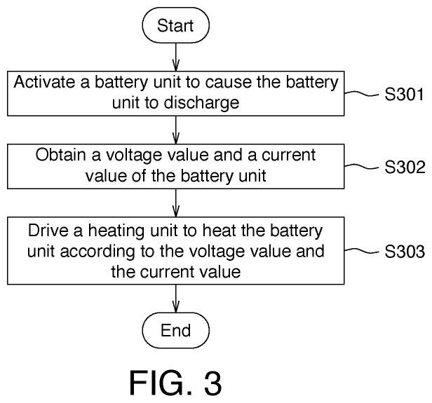

Referring to FIG. 3, a flowchart of a battery power optimization method according to an embodiment of the present invention is shown. The battery power optimization method of FIG. 3 can be used in the embodiments of FIG. 1 and FIG. 2.

In step S301, a battery unit is activated to cause the battery unit to discharge.

In step S302, a voltage value and a current value of the battery unit are obtained. For example, the current value and the voltage value of the battery unit are obtained by a detection unit.

In step S303, a heating unit is driven to heat the battery unit according to the voltage value and the current value. For example, the heating unit is driven by the drive control unit to heat the battery unit.

Details and variations of steps S301˜S303 can be obtained with reference to above disclosure and are not repeated here.

According to the present invention, whether to drive the heating unit to heat the battery unit is determined according to the current value and the voltage value of the battery unit obtained through detection. The battery unit can be heated, so that the impedance value of the battery unit can be reduced, and the current outputted by the battery unit can be large enough to drive the load. Particularly, at a cold outdoor environment, the battery unit is normally operated at a low temperature. The present invention is capable of resolving the time consuming process to activate an electronic device when the environmental temperature is too low.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A battery module, comprising:
a battery unit;
a heating unit;
a detection unit coupled to the battery unit and configured to obtain a voltage value and a current value of the battery unit;
a drive control unit coupled to the detection unit and the heating unit and configured to drive the heating unit to heat the battery unit according to the voltage value and the current value.

2. The battery module according to claim 1, wherein the drive control unit calculates an impedance value of the battery unit according to the voltage value and the current value and drive the heating unit to heat the battery unit according to the impedance value.

3. The battery module according to claim 1, wherein the drive control unit stores a conversion table; the drive control unit obtains an impedance value of the battery unit by looking up the conversion table according to the voltage value and the current value and drives the heating unit to heat the battery unit according to the impedance value.

4. The battery module according to claim 1, wherein the drive control unit determines an impedance value of the battery unit according to the voltage value and the current value and compares the impedance value with an upper limit and a lower limit to determine a driving current value for driving the heating unit.

5. The battery module according to claim 4, wherein the drive control unit records a usage state of the battery unit and adjusts the upper limit and the lower limit according to the usage state.

6. The battery module according to claim 1, wherein the drive control unit determines an impedance value of the battery unit according to the voltage value and the current value and compares the impedance value with a target impedance value to determine a driving current value for driving the heating unit.

7. A circuit board, comprising:
a battery slot configured to arrange a battery unit;
a heating unit;
a detection unit configured to obtain a voltage value and a current value of the battery unit;
a drive control unit coupled to the detection unit and the heating unit and configured to drive the heating unit to heat the battery unit according to the voltage value and the current value.

8. The circuit board according to claim 7, wherein the drive control unit calculates an impedance value of the battery unit according to the voltage value and the current value and drives the heating unit to heat the battery unit according to the impedance value.

9. The circuit board according to claim 7, wherein the drive control unit stores a conversion table; the drive control unit obtains an impedance value of the battery unit by looking up the conversion table according to the voltage value and the current value and drives the heating unit to heat the battery unit according to the impedance value.

10. The circuit board according to claim 7, wherein the drive control unit determines an impedance value of the battery unit according to the voltage value and the current value and compares the impedance value with an upper limit and a lower limit to determine a driving current value for driving the heating unit.

11. The circuit board according to claim 10, wherein the drive control unit records a usage state of the battery unit and adjusts the upper limit and the lower limit according to the usage state.

12. The circuit board according to claim 7, wherein the drive control unit determines an impedance value of the battery unit according to the voltage value and the current value and compares the impedance value with a target impedance value to determine a driving current value for driving the heating unit.

13. A battery power optimization method, comprising:
activating a battery unit to cause the battery unit to discharge;
obtaining a voltage value and a current value of the battery unit; and
driving a heating unit to heat the battery unit according to the voltage value and the current value.

14. The battery power optimization method according to claim 13, wherein the step of driving a heating unit to heat the battery unit according to the voltage value and the current value comprises:
obtaining an impedance value of the battery unit by looking up table according to the voltage value and the current value; and
driving the heating unit to heat the battery unit according to the impedance value.

15. The battery power optimization method according to claim 13, wherein the step of driving a heating unit to heat the battery unit according to the voltage value and the current value comprises:
calculating an impedance value of the battery unit according to the voltage value and the current value; and
driving the heating unit to heat the battery unit according to the impedance value.

16. The battery power optimization method according to claim 13, wherein the step of driving a heating unit to heat the battery unit according to the voltage value and the current value comprises:
obtaining an impedance value of the battery unit according to the voltage value and the current value; and
comparing the impedance value with an upper limit and a lower limit to determine a driving current value for driving the heating unit.

17. The battery power optimization method according to claim 16, further comprising:
recording a usage state of the battery unit; and
adjusting the upper limit and the lower limit according to the usage state.

18. The battery power optimization method according to claim 13, wherein the step of driving a heating unit to heat the battery unit according to the voltage value and the current value comprises:
obtaining an impedance value of the battery unit according to the voltage value and the current value; and
comparing the impedance value with a target impedance value to determine a driving current value for driving the heating unit.

19. The battery power optimization method according to claim 18, further comprising:
recording a usage state of the battery unit; and
adjusting the target impedance value according to the usage state.
